(19) United States
(12) Patent Application Publication
(10) Pub. No.: US 2010/0268929 A1
(43) Pub. Date: Oct. 21, 2010

(54) ELECTRONIC DEVICE AND SETTING METHOD THEREOF

(75) Inventor: Fumiyoshi TEZUKA, Tokyo (JP)

Correspondence Address: PATTERSON & SHERIDAN, L.L.P., 3040 POST OAK BOULEVARD, SUITE 1500, HOUSTON, TX, 77056, US

(73) Assignee: KABUSHIKI KAISHA TOSHIBA, Tokyo (JP)

(21) Appl. No.: 12/702,637

(22) Filed: Feb. 9, 2010

(30) Foreign Application Priority Data
Apr. 15, 2009 (JP) 2009-099237

(51) Int. Cl. G06F 1/24

(52) U.S. Cl. 713/100

(57) ABSTRACT

According to one embodiment, an electronic device that is configured to be removably connected to a host device includes a first storage module, a first determination module, and a setting change module. The first storage module stores a data file received from the host device. Each time a data file is newly stored in the first storage module, the first determination module determines whether the data file contains setting instruction information instructing to change a setting of the electronic device. When the first determination module determines that the data file contains the setting instruction information, the setting change module changes the setting of the electronic device as instructed by the setting instruction information.

### CROSS-REFERENCE TO RELATED APPLICATIONS

This application is based upon and claims the benefit of priority from Japanese Patent Application No. 2009-099237, filed Apr. 15, 2009, the entire contents of which are incorporated herein by reference.

### BACKGROUND

1. Field

One embodiment of the invention relates to an electronic device configured to be connected to a host device and a setting method thereof.

2. Description of the Related Art

Image capture devices such as digital cameras are commonly used. Such an image capture device is provided with an imaging device such as a charge-coupled device (CCD) image sensor that receives light reflected from an object and passing through an imaging lens to form an image of the object. In the image capture device, it is often the case that the image of the object is stored as an image fail in a storage medium such as an SD card (registered trademark) removably connected to the image capture device. In recent years, there has been proposed an electronic device in which a storage medium itself is provided with a wireless local area network (LAN) function. Through the use of the electronic device by mounting it on the image capture device, the image file created by imaging can be automatically transmitted to an external device. Such a conventional electronic device is disclosed in, for example, “Eye-Fi company”, on line, retrieved on Apr. 18, 2009, the Internet <URL:http://www.eye.fi/>.

The conventional electronic device needs a setting device such as a personal computer (PC) to set a transmission destination of the image file and the like. This makes it troublesome to change the settings and decreases the convenience. Further, the electronic device is independent of the image capture device, i.e., a host device, and therefore, the settings cannot be changed directly through the operation panel or the like of the host device. The direct change of the settings requires to additionally provide the host device with an interface or the like for the settings of the electronic device.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram of a host device using an electronic device according to an embodiment of the invention;

FIG. 2 is an exemplary block diagram of a wireless communication card according to a first embodiment of the invention;

FIG. 3 is an exemplary block diagram of a controller illustrated in FIG. 2 in the first embodiment;

FIG. 4 is an exemplary block diagram of an image capture device as an example of the host device in the first embodiment;

FIG. 5 is an exemplary flowchart of the operation of a recognition module illustrated in FIG. 3 in the first embodiment;

FIG. 6 is an exemplary block diagram of a controller of a wireless communication card according to a second embodiment of the invention;

FIG. 7 is an exemplary block diagram of a recorder as an example of the host device in the second embodiment;

FIG. 8 is an exemplary flowchart of the operation of a recognition module illustrated in FIG. 6 in the second embodiment;

FIG. 9 is an exemplary block diagram of a controller of a wireless communication card according to a third embodiment of the invention;

FIG. 10 is an exemplary block diagram of a letter input device as an example of the host device in the third embodiment;

FIG. 11 is an exemplary flowchart of the operation of a recognition module illustrated in FIG. 9 in the third embodiment;

FIG. 12 is an exemplary block diagram of a controller of a wireless communication card according to a fourth embodiment of the invention; and

FIG. 13 is an exemplary flowchart of the operation of a recognition module illustrated in FIG. 12 in the fourth embodiment.

### DETAILED DESCRIPTION

Various embodiments according to the invention will be described hereinafter with reference to the accompanying drawings. In general, according to one embodiment of the invention, an electronic device configured to be removably connected to a host device comprises a first storage module, a first determination module, and a setting change module. The first storage module is configured to store a data file received from the host device. The first determination module is configured to determine, each time a data file is newly stored in the first storage module, whether the data file contains setting instruction information instructing to change a setting of the electronic device. The setting change module is configured to change, when the first determination module determines that the data file contains the setting instruction information, the setting of the electronic device as instructed by the setting instruction information.

According to another embodiment of the invention, there is provided a setting method applied to an electronic device configured to be removably connected to a host device. The setting method comprises: a storage controller storing a data file received from the host device in a storage module; a determination module determining, each time a data file is newly stored in the storage module, whether the data file contains setting instruction information instructing to change a setting of the electronic device; and a setting change module changing, when the determination module determines that the data file contains the setting instruction information, the setting of the electronic device as instructed by the setting instruction information.

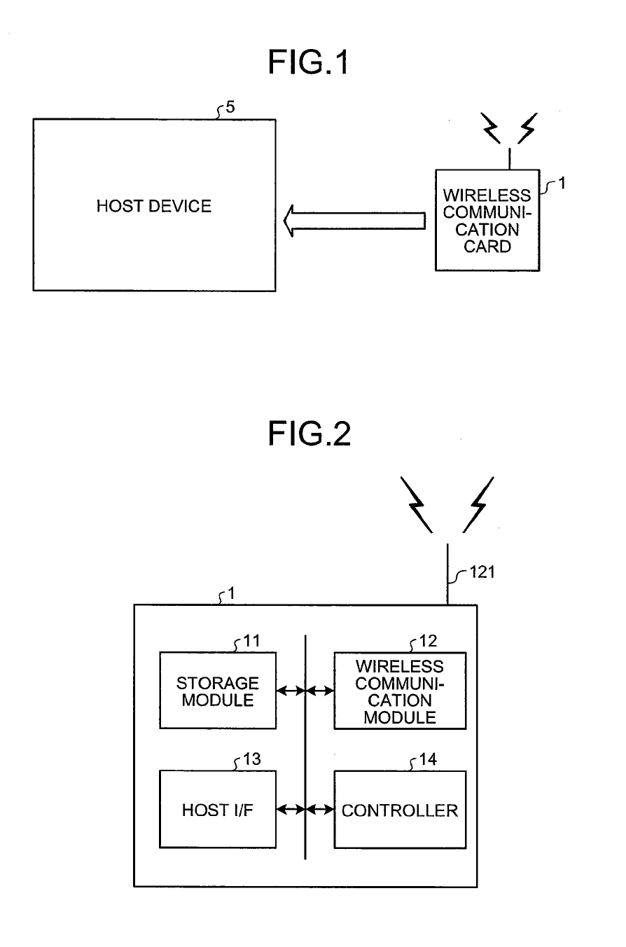

FIG. 1 is a schematic diagram of a host device 5 using an electronic device according to an embodiment of the invention. By way of example, the electronic device will be described herein as a wireless communication card 1 and as being removably connected to the host device 5.

The wireless communication card 1 is formed of a small card device such as an SD card (registered trademark), and has the wireless communication function of communicating via wireless with an external device. The host device 5 having mounted the wireless communication card 1 thereon connects via wireless to an external device through the wireless communication card 1, thereby communicating data with the external device.

The wireless communication card 1 comprises a nonvolatile storage medium (described later as a storage module 11), and manages the storage medium based on a predetermined file system. By recognizing the file system of the wireless communication card 1 mounted thereon, the host device 5 can handle the wireless communication card 1 as a storage device such as, for example, a removable storage device. That is, the wireless communication card 1 enables the host device 5 to function as a storage for data as well as a network terminal capable of wireless connection to an external device.

FIG. 2 is a block diagram of the wireless communication card 1 according to a first embodiment of the invention. As illustrated in FIG. 2, the wireless communication card 1 comprises the storage module 11, a wireless communication module 12, a host interface (I/F) 13, and a controller 14.

The storage module 11 is a nonvolatile storage medium such as an electrically erasable programmable read only memory (EEPROM), and is capable of storing various types of data files. The storage module 11 is used as a storage medium of the wireless communication card 1. Data files stored in the storage module 11 are managed by a predetermined file system recognizable by the host device 5 such as a file allocation table (FAT).

The storage module 11 stores file management information (sometimes referred to as “file system information”) for managing the data files stored in the storage module 11. That is, the storage module 11 has a data storage area, i.e., a storage area for storing the data files, and a file management information storage area, i.e., a storage area for storing the file management information.

The file management information includes directory entry information corresponding to each data file stored in the data storage area and FAT information indicating the storage location of each data file. The directory entry information includes information on a corresponding data file such as the file name, the attribute, the creation date and time, the file size, and the first cluster number of the data file. Meanwhile, the FAT information includes information for managing each data file in a storage location on the storage module 11 in units of a predetermined data size (in units of data blocks). By referring to the file management information of the wireless communication card 1, the host device 5 can access each data file stored in the storage module 11 (the data storage area).

The data storage area also stores setting information and a program for controlling the operation and function of the wireless communication card 1. The wireless communication card 1 operates as specified by the setting information under the control of the controller 14. The content of the setting information is not particularly limited as long as it is related to the wireless communication card 1. Examples of the setting information include the address of an external device to which the wireless communication card 1 is to be connected, whether the storage module 11 is accessible for an external device (file share setting), types of files exchangable with the host device 5 and an external device, and the like.

The wireless communication module 12 is a wireless communication device that establishes a wireless communication with an external device using an antenna 121. The wireless communication module 12 communicates via wireless with an external device based on the IEEE 801 standard.

The host I/F 13 is an interface used to connect a wired communication path between the wireless communication card 1 and the host device 5. While the wireless communication card 1 is being mounted on the host device 5, the host I/F 13 is electrically and physically connected to the host device 5. The host I/F 13 communicates with the host device 5. That is, the host I/F 13 receives various types of commands and data files sent from the host device 5 as well as transmitting various types of data files to the host device 5.

Besides, the host I/F 13 notifies the controller 14 of a write command from the host device 5. Upon detecting that a new file has been written to the storage module 11, the host I/F 13 outputs notification information to a recognition module 143, which will be described later, to notify that the file has been written. Incidentally, a write command sent from the host device 5 to the host I/F 13 is not always a command to instruct to store a file, but may be an access command to a physical device such as in the case of sector write. Therefore, the host I/F 13 analysis a command received from the host device 5 and, only when the command instructs to write a file, outputs the notification information to the recognition module 143.

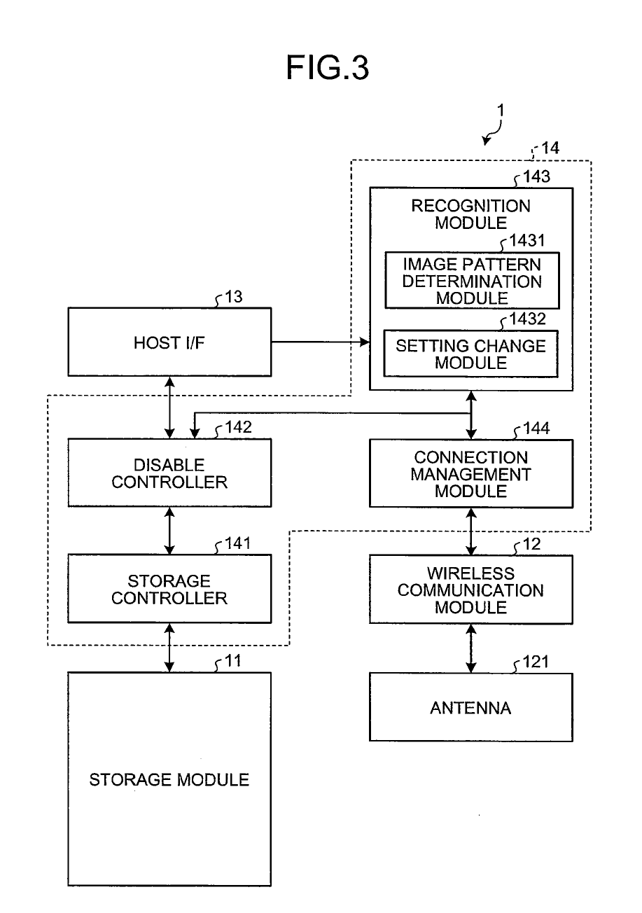

The controller 14 provides read/write access to the storage module 11 and the like according to a command received from the host device 5 through the host I/F 13. In the following, functional modules of the controller 14 will be described with reference to FIG. 3.

FIG. 3 illustrates a specific example of the configuration of the controller 14. As illustrated in FIG. 3, the controller 14 comprises functional modules including a storage controller 141, a disable controller 142, the recognition module 143, and a connection management module 144. These functional modules may be each implemented by hardware such as a processor or by a cooperation between a microprocessor and a predetermined program stored in the storage module 11 or the like.

According to a command received from the host device 5 through the host I/F 13 and the disable controller 142, the storage controller 141 writes a data file to (makes write access to) the storage module 11, or reads a data file from (makes read access to) the storage module 11. In addition, according to a command received from an external device through the antenna 121 and the wireless communication module 12, the storage controller 141 writes a data file to (makes write access to) the storage module 11, or reads a data file from (makes read access to) the storage module 11.

The disable controller 142 disables the write of a new data file to the storage module 11 during the recognition of setting information by the recognition module 143, which will be described later. The host I/F 13, the recognition module 143, and the connection management module 144 are configured to access the storage controller 141 via the disable controller 142.

Each time a data file is newly stored in the storage module 11, the recognition module 143 determines whether the data file contains setting instruction information that instructs to change the settings of the wireless communication card 1. Having determined that the data file contains the setting instruction information, the recognition module 143 changes the settings of the wireless communication card 1 as instructed by the setting instruction information.

More specifically, as illustrated in FIG. 3, the recognition module 143 comprises an image pattern determination module 1431 and a setting change module 1432. Each time having been notified by the host I/F 13 of completion of write operation, i.e., that a data file has been written, the image pattern determination module 1431 determines the type of the data file newly stored in the storage module 11, thereby determining whether the data file is an image file. The image pattern determination module 1431 determines the type of the data file based on, for example, additional information added to the header of the data file or the file name extension.

Having determined that the data file stored in the storage module 11 is an image file, the image pattern determination module 1431 recognizes (analyzes) an image represented by the image file. Thus, the image pattern determination module 1431 determines whether the image contains a predetermined image pattern that instructs to change the settings of the wireless communication card 1.

The image pattern may be a pattern, colors, a character string, or a combination thereof represented as an image, and is not particularly limited as long as it is recognizable by the image pattern determination module 1431. Examples of the image pattern include a “dot pattern” indicating ON/OFF of each setting item of the wireless communication card 1 in a mark sheet form, a “character pattern” formed of a string of handwritten or printed characters, a “code pattern” such as a bar code, a two-dimensional (2D) code, etc., and the like. The image pattern determination module 1431 determines whether the image pattern instructs to change the settings of the wireless communication card 1 by comparing the image pattern with a reference image pattern (template) for setting change stored in advance in the storage module 11 or a storage device (not illustrated).

According to the determination result of the image pattern determination module 1431, the setting change module 1432 regards the image pattern determined by the image pattern determination module 1431 to be the one instructing to change the settings of the wireless communication card 1 as setting instruction information. Thus, the setting change module 1432 changes the setting information of the wireless communication card 1 stored in the storage module 11 as instructed by the image pattern.

Setting items that may be changed by the setting instruction information are not particularly limited as long as they are related to the wireless communication card 1. As examples of the setting items may be cited the address of an external device to be connected to the wireless communication module 12, accessibility to the storage module 11 for an external device, types of files exchangeable with the host device 5 or an external device.

The connection management module 144 manages an external device to be connected to the wireless communication module 12 based on the setting information stored in the storage module 11. More specifically, if the setting information contains the address of an external device, the connection management module 144 controls the wireless communication module 12 to connect the external device with the address. Besides, according to whether the storage module 11 is accessible for the external device, the connection management module 144 controls access to the storage module 11. Further, if types of files exchangeable with the external device are specified, the connection management module 144 performs filtering so that only files of the specified types are exchanged with the external device.

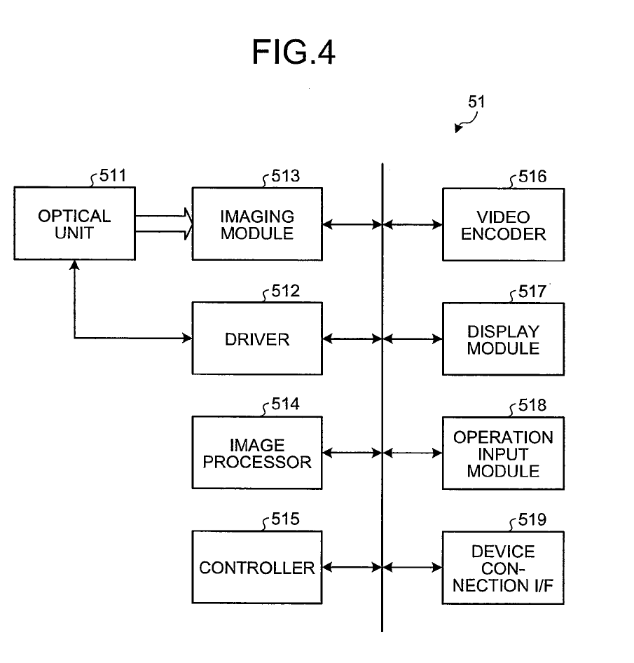

In the following, a description will be given of an example of the host device 5 applied to the wireless communication card 1 of the first embodiment. FIG. 4 is a block diagram of an image capture device 51 as an example of the host device 5. The image capture device 51 may be, for example, a digital camera or a video camera.

As illustrated in FIG. 4, the image capture device 51 comprises an optical unit 511, a driver 512, an imaging module 513, an image processor 514, a controller 515, a video encoder 516, a display module 517, an operation input module 518, and a device connection I/F 519.

The optical unit 511 comprises optical instruments such as an imaging lens, a diaphragm, and a shutter (none of them illustrated), and focuses an image of an object on an imaging device of the imaging module 513. The driver 512 outputs a control signal to the imaging lens, the diaphragm, and the shutter that constitute the optical unit 511, thereby driving the optical unit 511.

The imaging module 513 comprises the imaging device such as a charge-coupled device (CCD), a complementary metal oxide semiconductor (CMOS), or the like. The imaging module 513 receives light reflected from an object through the optical unit 511 in units of frames, and converts the light into a photoelectric current to output an analog electrical signal. The analog electrical signal output from the imaging module 513 is converted to a digital electrical signal by an analog-to-digital (A/D) converter (not illustrated), and output as image data.

The image processor 514 performs various types of image processing on the image data obtained by the imaging module 513 and also converts the image data to the one suitable to be recorded or displayed. For example, to record image data of an captured image or to display recorded image data, the image processor 514 compresses or decompresses the image data by joint photographic experts group (JPEG) method or the like. The image data processed by the image processor 514 is stored as an image file in the storage module 11 of the wireless communication card 1 through the device connection I/F 519, or is output to the video encoder 516 to be displayed on the display module 517.

The controller 515 comprises a central processing unit (CPU), a read only memory (ROM), a random access memory (ROM), and the like. In response to an operation signal or the like from the operation input module 518, the controller 515 reads a predetermined program from the ROM and executes it. Thus, the controller 515 sends a command or data to each constituent element of the image capture device 51 to control the overall operation of the image capture device 51.

The video encoder 516 outputs the image data converted to be displayed to the display module 517 so that the display module 517 displays the image data. For example, in image capture mode, the video encoder 516 displays an image, which has been captured frame-by-frame by the imaging module 513 and processed by the image processor 514, on the display module 517 in units of frames while switching the frames to display a live view image. On the other hand, in reproduction mode, the video encoder 516 displays image data, which has been read from the wireless communication card 1 and processed by the image processor 514, on the display module 517.

The display module 517 displays, in addition to the image data, information on various settings of the image capture device 51 and the like. The display module 517 comprises a display device such as a liquid crystal display (LCD) or an electroluminescent (EL) display.

The operation input module 518 receives input by user operation to, for example, instruct to start capturing an image, set a mode such as image capture mode or reproduction mode, set conditions for capturing an image, and the like, and outputs an operation signal to the controller 515. The operation input module 518 comprises buttons and switches each assigned a function.

The device connection I/F 519 communicates with the wireless communication card 1 mounted on the image capture device 51. More specifically, the device connection I/F 519 sends a command and data received from the controller 515 to the wireless communication card 1 as well as receiving data transmitted from the wireless communication card 1.

Upon changing the settings of the wireless communication card 1 as to the function and the operation, the user of the image capture device 51 instructs new settings using the imaging function of the image capture device 51. More specifically, the user of the image capture device 51 creates an image pattern representing desired settings of the wireless communication card 1 on a medium such as a paper sheet based on a predetermined template. Then, the user captures an image of the medium with the image capture device 51 having the wireless communication card 1 mounted thereon. With this, an image pattern representing the settings of the wireless communication card 1 is stored in the wireless communication card 1 as an image file. Under the control of the recognition module 143, the settings represented by the image pattern are reflected in the setting information of the wireless communication card 1.

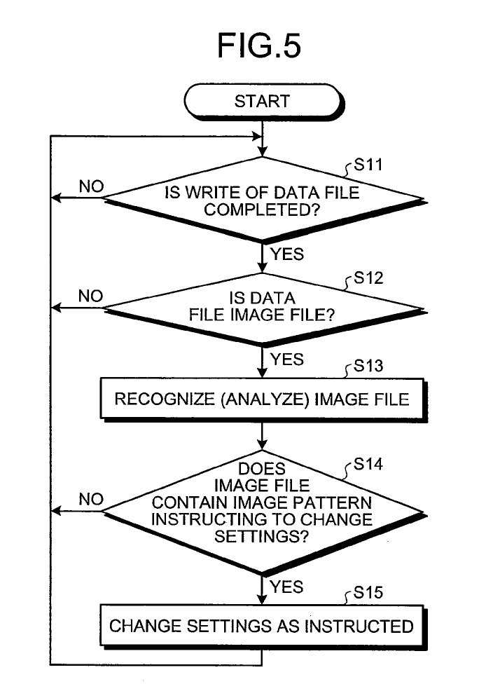

With reference to FIG. 5, a description will be given of the operation of the wireless communication card 1 to change the settings. FIG. 5 is a flowchart of the operation of the recognition module 143.

First, the image pattern determination module 1431 waits for receipt of notification that a data file has been written, i.e., the write of a data file is completed, from the host I/F 13 (No at S11). Having received notification that a data file has been written (Yes at S11), the image pattern determination module 1431 determines the type of the data file newly stored in the storage module 11, thereby determining whether the data file is an image file (S12).

When the image pattern determination module 1431 determines that the data file is not an image file (No at S12), the process returns to S11. On the other hand, having determined that the data file is an image file (Yes at S12), the image pattern determination module 1431 recognizes (analyzes) an image represented by the image file (S13).

Then, the image pattern determination module 1431 determines whether the image file contains a predetermined image pattern that instructs to change the settings of the wireless communication card 1 based on the result of S13 (S14). When a predetermined image pattern is not recognized that instructs to change the settings of the wireless communication card 1 (No at S14), the process returns again to S11.

On the other hand, when the image pattern determination module 1431 recognizes a predetermined image pattern that instructs to change the settings of the wireless communication card 1 (Yes at S14), the setting change module 1432 regards the image pattern as setting instruction information, and changes the setting information of the wireless communication card 1 stored in the storage module 11 as instructed by the image pattern (S15). Thereafter, the process returns again to S11.

As described above, according to the first embodiment, an image file representing the settings of the wireless communication card 1 is created using the imaging function of the host device 5. The image file is stored in the storage module 11 built in the wireless communication card 1. With this, the settings of the wireless communication card 1 can be changed to desired settings. In other words, the settings of the wireless communication card 1 connected to the host device 5 can be changed without modification of the existing host device 5.

While the recognition module 143 is described above as performing the processing with respect to a data file (an image file) created by the image capture device 51, this is by way of example and not of limitation. The recognition module 143 may perform the same processing on a data file (an image file) received via the wireless communication module 12 from an external device.

Besides, while the recognition module 143 is described above as operating in response to notification from the host I/F 13 that a data file has been written as a trigger, it is not so limited. The recognition module 143 may monitor the file system of the storage module 11 and perform the above processing on a data file that has been updated.

Further, while the recognition module 143 is described above as performing the image pattern recognition with respect to all image files stored in the storage module 11 (S13 and S14), it is not so limited. For example, the recognition module 143 may determine whether the image size, resolution, or the like of each image file satisfies a predetermined condition before the image pattern recognition, and perform the image pattern recognition only when the image file satisfies the condition. With this, the recognition process can be reduced.

In the following, a second embodiment of the invention will be described. In the fires embodiment, an example is described in which, of data files stored in the storage module 11, an image file is used to change the settings. However, files of other types are similarly applicable. In the second embodiment, an example will be described in which an audio file is used to change the settings. Incidentally, constituent elements corresponding to those described in the first embodiment are designated by the same reference numerals, and their description will not be repeated.

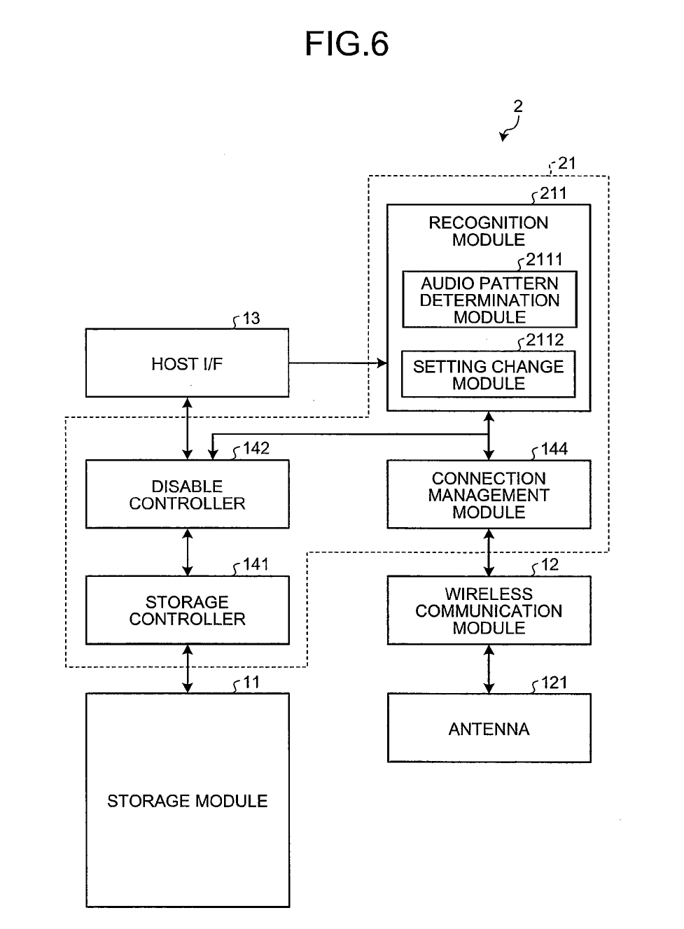

FIG. 6 illustrates a specific example of the configuration of a controller 21 of a wireless communication card 2 according to the second embodiment. As illustrated in FIG. 6, the controller 21 comprises functional modules including the storage controller 141, the disable controller 142, a recognition module 211, and the connection management module 144. These functional modules may be each implemented by hardware such as a processor or by a cooperation between a processor and a predetermined program (software) stored in the storage module 11 or the like.

Each time a data file is newly stored in the storage module 11, the recognition module 211 determines whether the data file contains setting instruction information that instructs to change the settings of the wireless communication card 2. Having determined that the data file contains the setting instruction information, the recognition module 211 changes the settings of the wireless communication card 2 as instructed by the setting instruction information.

More specifically, as illustrated in FIG. 6, the recognition module 211 comprises an audio pattern determination module 2111 and a setting change module 2112. Each time having been notified by the host I/F 13 of completion of write operation, i.e., that a data file has been written, the audio pattern determination module 2111 determines the type of the data file newly stored in the storage module 11, thereby determining whether the data file is an audio file. Having determined that the data file stored in the storage module 11 is an audio file, the audio pattern determination module 2111 recognizes (analyzes) an audio pattern represented by the audio file. Thus, the audio pattern determination module 2111 determines whether the audio pattern instructs to change the settings of the wireless communication card 2.

The audio pattern may be the settings vocally provided by the user. The language is not particularly limited as long as it is recognizable by the audio pattern determination module 2111. The audio pattern determination module 2111 determines whether the audio pattern instructs to change the settings of the wireless communication card 2 by comparing the audio pattern with a reference audio pattern (template) for setting change stored in advance in the storage module 11 or a storage device (not illustrated). The audio pattern is recognized by a commonly known audio recognition technology.

According to the determination result of the audio pattern determination module 2111, the setting change module 2112 regards the audio pattern determined to be the one instructing to change the settings of the wireless communication card 2 as setting instruction information. Thus, the setting change module 2112 changes the setting information of the wireless communication card 2 stored in the storage module 11 as instructed by the audio pattern.

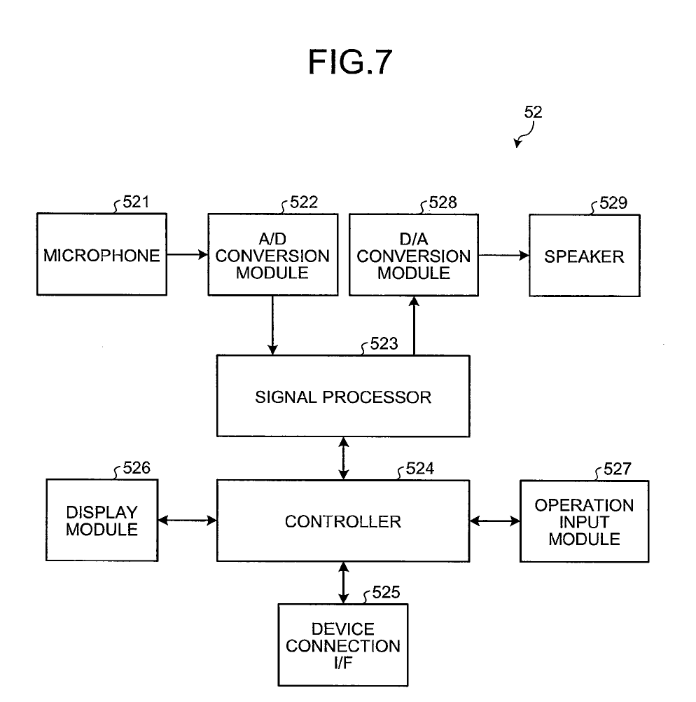

In the following, a description will be given of an example of the host device 5 applied to the wireless communication card 2 of the second embodiment. FIG. 7 is a block diagram of a recorder 52 as an example of the host device 5. The recorder 52 may be, for example, an integrated circuit (IC) recorder or a portable music player.

As illustrated in FIG. 7, the recorder 52 comprises a microphone 521, an A/D conversion module 522, a signal processor 523, a controller 524, a device connection I/F 525, a display module 526, an operation input module 527, a D/A conversion module 528, and a speaker 529.

The microphone 521 converts audio into an electrical signal, and outputs it to the A/D conversion module 522. The A/D conversion module 522 comprises a preamplifier, a low pass filter, and an A/D converter. The A/D conversion module 522 converts the electrical signal received from the microphone 521 to a digital signal. The signal processor 523 encodes or decodes the digital signal converted from analog to digital by the A/D conversion module 522.

The controller 524 comprises a CPU, a ROM, a ROM, and the like. In response to an operation signal or the like from the operation input module 527, the controller 524 reads a predetermined program from the ROM and executes it. Thus, the controller 524 controls the overall operation of the recorder 52.

More specifically, the controller 524 outputs the digital signal encoded by the signal processor 523 to the device connection I/F 525 as an audio file together with a write command to store the audio file in the wireless communication card 2 connected to the device connection I/F 525. Further, in response to notification from the operation input module 527, the controller 524 outputs a read command to read the audio file to the device connection I/F 525, thereby reading the audio file from the wireless communication card 2 connected to the device connection I/F 525.

The device connection I/F 525 communicates with the wireless communication card 2 mounted on the recorder 52. More specifically, the device connection I/F 525 sends various types of commands and data files received from the controller 524 to the wireless communication card 2 as well as receiving data files transmitted from the wireless communication card 2.

The display module 526 displays information related to the operation state of the recorder 52 and recorded content. The display module 526 comprises a display device such as an LCD or an EL display. The operation input module 527 receives input by user operation, and outputs an operation signal to the controller 524. The operation input module 527 comprises buttons and switches each assigned a function.

The D/A conversion module 528 comprises a power amplifier, a low pass filter, and a D/A converter. The D/A conversion module 528 converts the audio file having undergone the signal processing by the signal processor 523 to an analog electrical signal. The speaker 529 converts the electrical signal converted from digital to analog by the D/A conversion module 528 to audio.

Upon changing the settings of the wireless communication card 2 as to the function and the operation, the user of the recorder 52 instructs new settings using the recording function of the recorder 52. More specifically, the user of the recorder 52 vocally provides desired settings of the wireless communication card 2 in a form based on a predetermined template, and records the voice with the recorder 52 having the wireless communication card 2 mounted thereon. With this, an audio pattern representing the settings of the wireless communication card 2 is stored in the wireless communication card 2 as an audio file. Under the control of the recognition module 211, the settings represented by the audio pattern are reflected in the setting information of the wireless communication card 2.

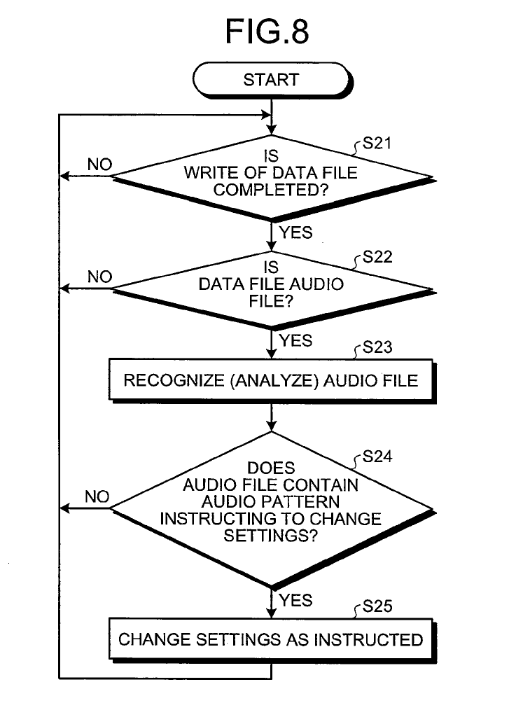

With reference to FIG. 8, a description will be given of the operation of the wireless communication card 2 to change the settings. FIG. 8 is a flowchart of the operation of the recognition module 211.

First, the audio pattern determination module 2111 waits for receipt of notification that a data file has been written, i.e., the write of a data file is completed, from the host I/F 13 (No at S21). Having received notification that a data file has been written (Yes at S21), the audio pattern determination module 2111 determines the type of the data file newly stored in the storage module 11, thereby determining whether the data file is an audio file (S22).

When the audio pattern determination module 2111 determines that the data file is not an audio file (No at S22), the process returns to S21. On the other hand, having determined that the data file is an audio file (Yes at S22), the audio pattern determination module 2111 recognizes (analyzes) audio represented by the audio file (S23).

Then, the audio pattern determination module 2111 determines whether the audio file contains an audio pattern that instructs to change the settings of the wireless communication card 2 based on the result of S23 (S24). When such an audio pattern is not recognized that instructs to change the settings of the wireless communication card 2 (No at S24), the process returns again to S21.

On the other hand, when the audio pattern determination module 2111 recognizes an audio pattern that instructs to change the settings of the wireless communication card 2 (Yes at S24), the setting change module 2112 regards the audio pattern as setting instruction information, and changes the setting information stored in the storage module 11 as instructed by the audio pattern (S25). Thereafter, the process returns again to S21.

As described above, according to the second embodiment, an audio file representing the settings of the wireless communication card 2 is created using the recording function of the host device 5. The audio file is stored in the storage module 11 built in the wireless communication card 2. With this, the settings of the wireless communication card 2 can be changed to desired settings. In other words, the settings of the wireless communication card 2 connected to the host device 5 can be changed without modification of the existing host device 5.

While the recognition module 211 is described above as performing the processing with respect to a data file (an audio file) created by the recorder 52, this is by way of example and not of limitation. The recognition module 211 may perform the same processing on a data file (an audio file) received via the wireless communication module 12 from an external device.

Besides, while the recognition module 211 is described above as operating in response to notification from the host I/F 13 that a data file has been written as a trigger, it is not so limited. The recognition module 211 may monitor the file system of the storage module 11 and perform the above processing on a data file that has been updated.

Further, while the recognition module 211 is described above as performing the audio pattern recognition with respect to all audio files stored in the storage module 11 (S23 and S24), it is not so limited. For example, the recognition module 211 may determine whether the data size, sampling frequency, or the like of each audio file satisfies a predetermined condition before the audio pattern recognition, and perform the audio pattern recognition only when the audio file satisfies the condition. With this, the recognition process can be reduced.

In the following, a third embodiment of the invention will be described. In the third embodiment, an example will be described in which a text file is used to change the settings. Incidentally, constituent elements corresponding to those described in the first embodiment are designated by the same reference numerals, and their description will not be repeated.

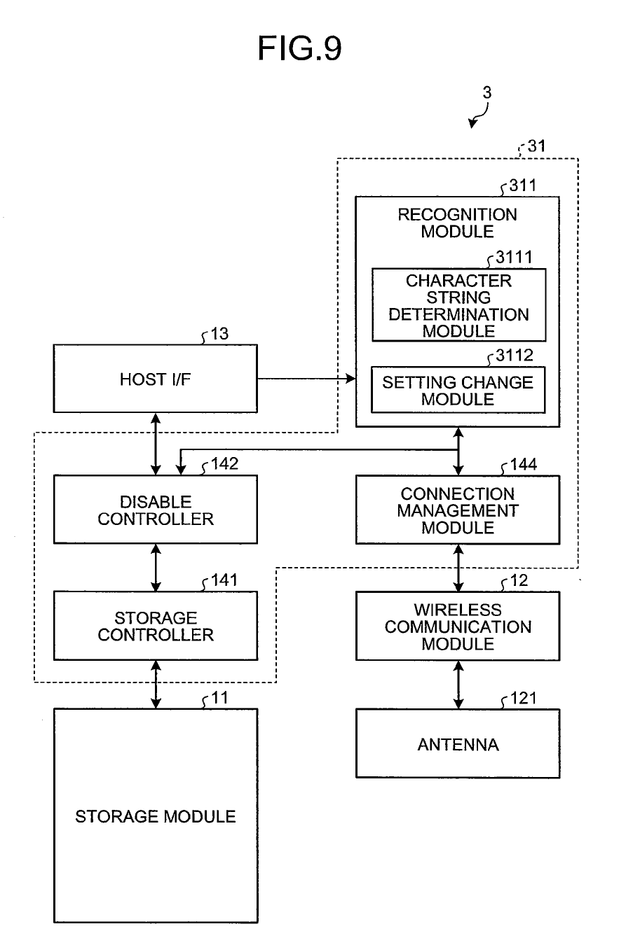

FIG. 9 illustrates a specific example of the configuration of a controller 31 of a wireless communication card 3 according to the third embodiment. As illustrated in FIG. 9, the controller 31 comprises functional modules including the storage controller 141, the disable controller 142, a recognition module 311, and the connection management module 144. These functional modules may be each implemented by hardware such as a processor or by a cooperation between a processor and a predetermined program (software) stored in the storage module 11 or the like.

Each time a data file is newly stored in the storage module 11, the recognition module 311 determines whether the data file contains setting instruction information that instructs to change the settings of the wireless communication card 3. Having determined that the data file contains the setting instruction information, the recognition module 311 changes the settings of the wireless communication card 3 as instructed by the setting instruction information.

More specifically, as illustrated in FIG. 9, the recognition module 311 comprises a character string determination module 3111 and a setting change module 3112. Each time having been notified by the host I/F 13 of completion of write operation, i.e., that a data file has been written, the character string determination module 3111 determines the type of the data file newly stored in the storage module 11, thereby determining whether the data file is a text file. The character string determination module 3111 determines the type of the data file based on, for example, additional information added to the header of the data file or the file name extension.

Having determined that the data file stored in the storage module 11 is a text file, the character string determination module 3111 recognizes (analyzes) a character string contained in the text file. Thus, the character string determination module 3111 determines whether the character string instructs to change the settings of the wireless communication card 3.

The text file may be a character string provided by the user represented by text data (text code). The character string determination module 3111 determines whether the character string instructs to change the settings of the wireless communication card 3 by comparing the character string with a reference character string (template) for setting change stored in advance in the storage module 11 or a storage device (not illustrated). The character string is recognized by a commonly known character string recognition technology such as morphological analysis.

According to the determination result of the character string determination module 3111, the setting change module 3112 regards the character string determined to be the one instructing to change the settings of the wireless communication card 3 as setting instruction information. Thus, the setting change module 3112 changes the setting information of the wireless communication card 3 stored in the storage module 11 as instructed by the character string.

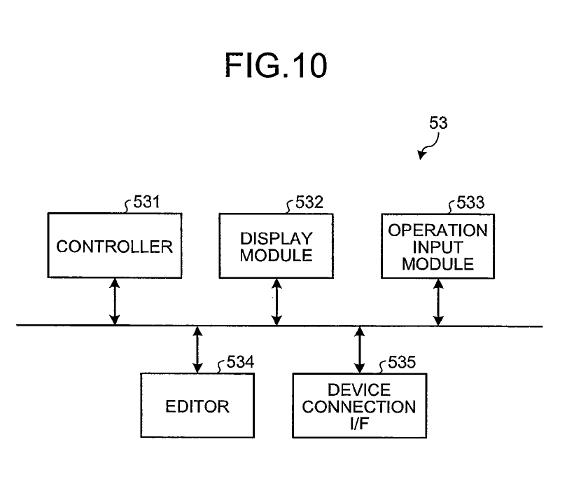

In the following, a description will be given of an example of the host device 5 applied to the wireless communication card 3 of the third embodiment. FIG. 10 is a block diagram of a character input device 53 as an example of the host device 5. The character input device 53 may be, for example, a mobile telephone capable of creating a text file.

As illustrated in FIG. 10, the character input device 53 comprises a controller 531, a display module 532, an operation input module 533, an editor 534, and a device connection I/F 535. The controller 531 controls the overall operation of the character input device 53.

The controller 531 comprises a CPU, a ROM, a ROM, and the like. In response to an operation signal or the like from the operation input module 533, the controller 531 reads a predetermined program from the ROM and executes it. Thus, the controller 531 controls the overall operation of the character input device 53.

The display module 532 displays text, numbers, images, and the like under the control of the controller 531. The operation input module 533 comprises an input device such as a keyboard and, in response to user operation on the keyboard, notifies the controller 531 of an identifier of a key operated by the user. The display module 532 displays a character string input through the operation input module 533 on the screen.

The editor 534 is a functional module implemented by a cooperation between the controller 531 and a predetermined program. Upon receipt of a character string input through the operation input module 533, the editor 534 creates a text file representing the character string. The editor 534 outputs the text file to the device connection I/F 535 together with a write command, thereby storing the text file in the wireless communication card 3 connected to the device connection I/F 535.

Upon changing the settings of the wireless communication card 3, the user of the character input device 53 instructs new settings using the text file creation function of the character input device 53. More specifically, the user of the character input device 53 inputs a character string representing desired settings of the wireless communication card 3 in a form based on a predetermined template. With this, a text file representing the settings of the wireless communication card 3 is stored in the wireless communication card 3. Under the control of the recognition module 311, the settings represented by the text file are reflected in the setting information of the wireless communication card 3.

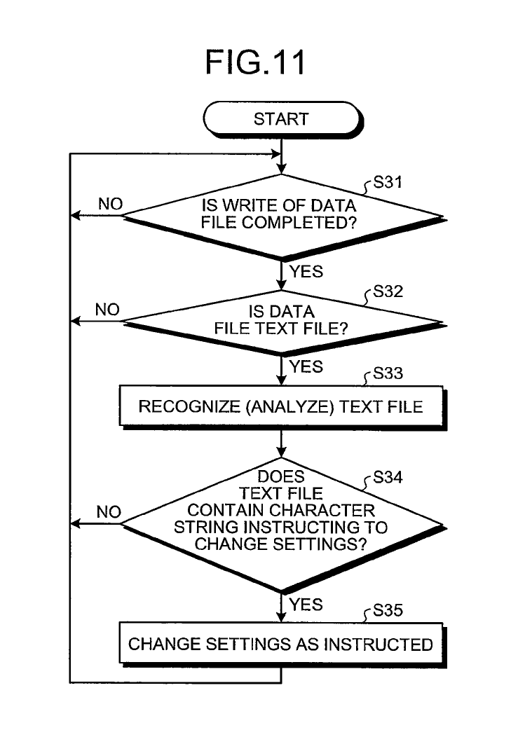

With reference to FIG. 11, a description will be given of the operation of the wireless communication card 3 to change the settings. FIG. 11 is a flowchart of the operation of the recognition module 311.

First, the character string determination module 3111 waits for receipt of notification that a data file has been written, i.e., the write of a data file is completed, from the host I/F 13 (No at S31). Having received notification that a data file has been written (Yes at S31), the character string determination module 3111 determines the type of the data file newly stored in the storage module 11, thereby determining whether the data file is a text file (S32).

When the character string determination module 3111 determines that the data file is not a text file (No at S32), the process returns to S31. On the other hand, having determined that the data file is a text file (Yes at S32), the character string determination module 3111 recognizes (analyzes) a character string contained in the text file (S33). Then, the character string determination module 3111 determines whether the character string instructs to change the settings of the wireless communication card 3 (S34).

When the character string determination module 3111 determines that the character string does not instruct to change the settings of the wireless communication card 3 (No at S34), the process returns again to S31. On the other hand, when the character string determination module 3111 determines that the character string instructs to change the settings of the wireless communication card 3 (Yes at S34), the setting change module 3112 regards the character string as setting instruction information, and changes the setting information stored in the storage module 11 as instructed by the character string (S35). Thereafter, the process returns again to S31.

As described above, according to the third embodiment, a text file representing the settings of the wireless communication card 3 is created using the editor function of the host device 5. The text file is stored in the storage module 11 built in the wireless communication card 3. With this, the settings of the wireless communication card 3 can be changed to desired settings. In other words, the settings of the wireless communication card 3 connected to the host device 5 can be changed without modification of the existing host device 5.

While the recognition module 311 is described above as performing the processing with respect to a data file (a text file) created by the character input device 53, this is by way of example and not of limitation. The recognition module 311 may perform the same processing on a data file (a text file) received via the wireless communication module 12 from an external device.

Besides, while the recognition module 311 is described above as operating in response to notification from the host I/F 13 that a data file has been written as a trigger, it is not so limited. The recognition module 311 may monitor the file system of the storage module 11 and perform the above processing on a data file that has been updated.

Further, while the recognition module 311 is described above as performing the character string recognition with respect to all text files stored in the storage module 11 (S33 and S34), it is not so limited. For example, the recognition module 311 may determine whether the data size or the like of each text file satisfies a predetermined condition before the character string recognition, and perform the character string recognition only when the text file satisfies the condition. With this, the recognition process can be reduced.

In the following, a fourth embodiment of the invention will be described. In the fourth embodiment, an example will be described in which security is improved for changing the settings of a wireless communication card. Incidentally, constituent elements corresponding to those described in the first embodiment are designated by the same reference numerals, and their description will not be repeated.

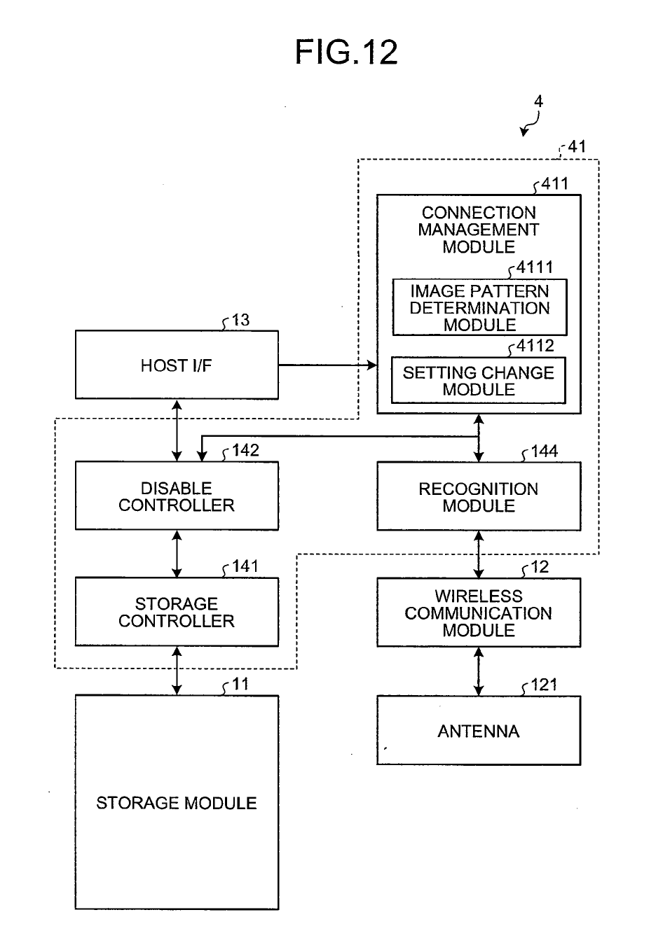

FIG. 12 illustrates a specific example of the configuration of a controller 41 of a wireless communication card 4 according to the fourth embodiment. As illustrated in FIG. 12, the controller 41 comprises functional modules including the storage controller 141, the disable controller 142, a recognition module 411, and the connection management module 144. These functional modules may be each implemented by hardware such as a processor or by a cooperation between a processor and a predetermined program (software) stored in the storage module 11 or the like.

The recognition module 411 has the same function as the recognition module 143 described above. Further, each time a data file is newly stored in the storage module 11, the recognition module 411 determines whether the data file contains identification information that identifies the user of the host device 5, and determines, if any, whether the identification information matches verification information. When the data file contains setting instruction information and also the identification information contained in the data file matches the verification information, the recognition module 411 changes the settings of the wireless communication card 4 as instructed by the setting instruction information.

More specifically, as illustrated in FIG. 12, the recognition module 411 comprises an image pattern determination module 4111 and a setting change module 4112.

Having been notified by the host I/F 13 of completion of write operation, i.e., that a data file has been written, the image pattern determination module 4111 determines the type of the data file newly stored in the storage module 11, thereby determining whether the data file is an image file. Having determined that the data file is an image file, the image pattern determination module 4111 determines whether the image file contains identification information for identifying the user. The identification information is information that identifies the user who changes the settings of the wireless communication card 4, and may be, for example, the sign or seal of the user.

Having determined that the image file contains identification information, the image pattern determination module 4111 compares the identification information with identification information of an authenticated user who is allowed to operate the wireless communication card 4 (hereinafter, “verification information”), thereby determining whether the two match. It is assumed herein that the verification information is stored in advance in a storage medium such as the storage module 11 of the wireless communication card 4.

According to the determination result of the image pattern determination module 4111, in the image file containing identification information that matches the verification information, the setting change module 4112 regards an image pattern determined to be the one instructing to change the settings of the wireless communication card 4 as setting instruction information. Thus, the setting change module 4112 changes the setting information of the wireless communication card 4 stored in the storage module 11 as instructed by the image pattern.

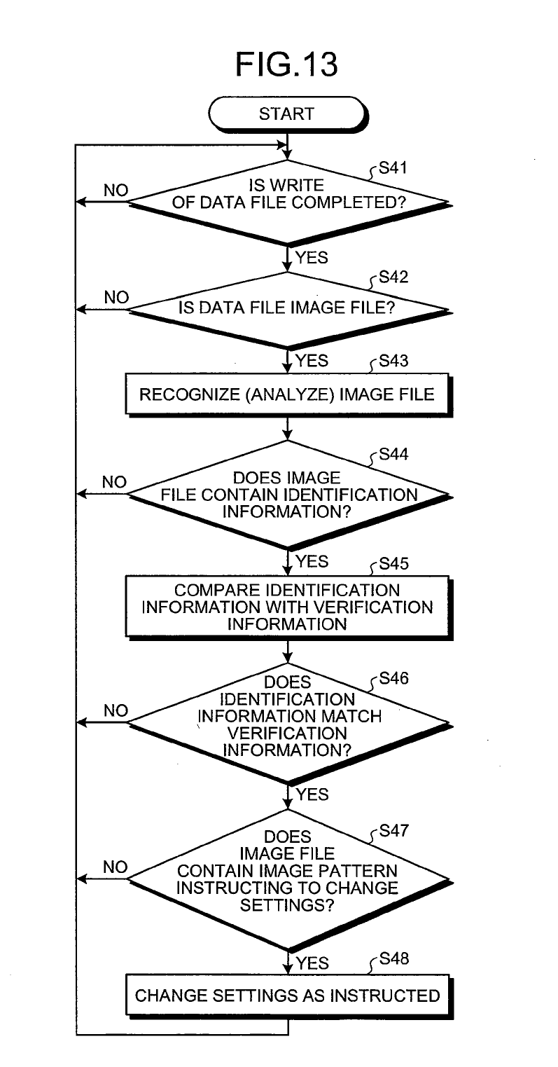

With reference to FIG. 13, a description will be given of the operation of the wireless communication card 4 to change the settings. FIG. 13 is a flowchart of the operation of the recognition module 411.

First, the image pattern determination module 4111 waits for receipt of notification that a data file has been written, i.e., the write of a data file is completed, from the host I/F 13 (No at S41). Having received notification that a data file has been written (Yes at S41), the image pattern determination module 4111 determines the type of the data file newly stored in the storage module 11, thereby determining whether the data file is an image file (S42).

When the image pattern determination module 4111 determines that the data file is not an image file (No at S42), the process returns to S41. On the other hand, having determined that the data file is an image file (Yes at S42), the image pattern determination module 4111 recognizes (analyzes) an image represented by the image file (S43).

Then, the image pattern determination module 4111 determines whether the image file contains identification information based on the result of S43 (S44). When the image pattern determination module 4111 determines that the image file does not contain identification information (No at S44), the process returns again to S41.

On the other hand, having determined that the image file contains identification information (Yes at S44), the image pattern determination module 4111 compares the identification information with verification information (S45) to determine whether the two match (S46). When the image pattern determination module 4111 determines that the identification information does not match the verification information (No at S46), the process returns again to S41.

Having determined that the identification information matches the verification information (Yes at S46), the image pattern determination module 4111 determines whether the image file contains a predetermined image pattern that instructs to change the settings of the wireless communication card 4 based on the result of S43 (S47). When a predetermined image pattern is not recognized that instructs to change the settings of the wireless communication card 4 (No at S47), the process returns again to S41.

On the other hand, when the image pattern determination module 4111 recognizes a predetermined image pattern that instructs to change the settings of the wireless communication card 4 (Yes at S47), the setting change module 4112 regards the image pattern as setting instruction information, and changes the setting information stored in the storage module 11 as instructed by the image pattern (S48). Thereafter, the process returns again to S41.

As described above, according to the fourth embodiment, only an authenticated user who is allowed to operate the wireless communication card 4 can change the settings of the wireless communication card 4. Thus, security can be improved in changing the settings of the wireless communication card 4.

In the fourth embodiment, whether to allow the change of the settings of the wireless communication card 4 is determined based on identification information contained in an image file. This may be applied to the wireless communication card 2 of the second embodiment. That is, whether to allow the change of the settings of the wireless communication card 2 may be determined based on identification information contained in an audio file.

More specifically, upon changing the settings of the wireless communication card connected to the host device 5 (the recorder 52), the user of the recorder 52 vocally provides a predetermined keyword as identification information together with desired settings, and records the voice with the recorder 52. The audio file thus created contains the identification information and the settings as an audio pattern. By comparing the identification information with verification information, it is possible to determine whether the user is an authenticated user who is allowed to operate the wireless communication card 2. Further, if the recognition module 211 has the function of extracting a voiceprint from the audio file, by comparing a voiceprint extracted from the audio file with that of an authenticated user stored as verification information, it is possible to determine whether the user is the authenticated user who is allowed to operate the wireless communication card 2.

The fourth embodiment may also be applied to the wireless communication card 3 of the third embodiment. That is, whether to allow the change of the settings of the wireless communication card 3 may be determined based on a key word contained in a text file as identification information.

More specifically, upon changing the settings of the wireless communication card connected to the host device 5 (the character input device 53), the user of the character input device 53 inputs a predetermined keyword as identification information together with desired settings as text. The text file thus created contains the identification information and the settings as a character string. By comparing the identification information with verification information, it is possible to determine whether the user is an authenticated user who is allowed to operate the wireless communication card.

While, in the embodiments described above, the settings of the wireless communication card is changed by using one of an image file, an audio file, and a text file, it is not so limited. For example, the wireless communication card may be provided with the functions of the recognition module 143, the recognition module 211, and the recognition module 311 in combination so that it can handle a plurality of file types.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic device configured to be removably connected to a host device, the electronic device comprising:
a first storage module configured to store a data file received from the host device;
a first determination module configured to determine, each time a data file is newly stored in the first storage module, whether the data file contains setting instruction information instructing to change a setting of the electronic device; and
a setting change module configured to change, when the first determination module determines that the data file contains the setting instruction information, the setting of the electronic device as instructed by the setting instruction information.

2. The electronic device of claim 1, wherein
the data file is an image file,
the first determination module is configured to determine whether the image file contains a predetermined image pattern instructing to change the setting of the electronic device, and
when the first determination module determines that the image file contains the image pattern, the setting change module regards the image pattern as the setting instruction information, and changes the setting of the electronic device as instructed by the image pattern.

3. The electronic device of claim 1, wherein
the data file is an audio file,
the first determination module is configured to determine whether the audio file contains a predetermined audio pattern instructing to change the setting of the electronic device, and
when the first determination module determines that the audio file contains the audio pattern, the setting change module regards the audio pattern as the setting instruction information, and changes the setting of the electronic device as instructed by the audio pattern.

4. The electronic device of claim 1, wherein
the data file is a text file,
the first determination module is configured to determine whether the text file contains a predetermined character string instructing to change the setting of the electronic device, and
when the first determination module determines that the text file contains the character string, the setting change module regards the character string as the setting instruction information, and changes the setting of the electronic device as instructed by the character string.

5. The electronic device of claim 1, further comprising:
a second storage module configured to store identification information that identifies a predetermined user as verification information; and
a second determination module configured to determine, each time a data file is newly stored in the first storage module, whether the data file contains identification information that matches the verification information, wherein
when the first determination module determines that the data file contains the setting instruction information and the second determination module determines that the data file contains identification information that matches the verification information, the setting change module changes the setting of the electronic device as instructed by the setting instruction information.

6. The electronic device of claim 1, further comprising a wireless communication module configured to communicate via wireless with an external device, wherein
the first storage module is configured to store a data file received from the external device through the wireless communication module.

7. A setting method applied to an electronic device configured to be removably connected to a host device, the setting method comprising:
a storage controller storing a data file received from the host device in a storage module;
a determination module determining, each time a data file is newly stored in the storage module, whether the data file contains setting instruction information instructing to change a setting of the electronic device; and
a setting change module changing, when the determination module determines that the data file contains the setting instruction information, the setting of the electronic device as instructed by the setting instruction information.
